(19) United States
(12) Patent Application Publication
(10) Pub. No.: US 2025/0146337 A1
(43) Pub. Date: May 8, 2025

(54) DOOR LATCH DEVICE

(71) Applicant: Minebea AccessSolutions France, Alfortville (FR)

(72) Inventors: Laurent DURIEZ, Alfortville (FR); François DEBROUCKE, Alfortville (FR); Jérémy PAUMELLE, Alfortville (FR)

(73) Assignee: Minebea AccessSolutions France, Alfortville (FR)

(21) Appl. No.: 18/895,480

(22) Filed: Sep. 25, 2024

(30) Foreign Application Priority Data
Sep. 28, 2023 (EP) 23315373.3

(51) Int. Cl. E05B 85/24; E05B 85/04

(52) U.S. Cl. CPC E05B 85/243; E05B 85/045

(57) ABSTRACT

A door latch device includes an insertion slot through which a striker can be inserted, a fork rotatable between a holding position of the striker and a releasing position of the striker, and a claw rotatable between a locking position locking the fork and an unlocking position of the fork. The fork includes a first locking protrusion facing a locking recess provided in the claw. Engagement of the locking protrusion in the locking recess locks the claw and the fork together. The fork includes a second locking protrusion configured to come into contact with an opposing side of the locking claw when it is in its locking position, but the first locking protrusion is not in contact with a bottom surface of the locking recess.

The invention relates to a door latch device for an automotive vehicle, in particular to avoid unsolicited opening of said door during a side crash scenario.

A conventional door latch device for an automotive vehicle usually comprises a latch mechanism including a fork and a claw, operated by a handle provided with the door. The latch mechanism is switched from the latched state to the unlatched state by operation of a handle provided in the door. In the latched state, the fork holds the striker and the claw locks the fork. In unlatching, the fork is unlocked by the claw, and the fork is disengaged from the striker. Releasing the latch allows the door to be opened.

When a vehicle undergoes a collision, particularly in the case of a lateral collision, the door is deformed due to the collision load. Due to this deformation of the door, when a large load is applied to the claw via the striker and the fork, the claw may be displaced out of the fork and the latch mechanism may be switched from the latched state to the unlatched state.

To avoid this, it is known to provide a latch mechanism that includes a holding fork and rotatable between a holding position in which it holds and immobilizes the striker and a releasing position in which its hold on the striker is released, and a locking claw disposed on the base member and rotatable between a locking position in which it locks the fork into the holding position and an unlocking position in which it unlocks the fork, the locking claw being biased from the unlocked position towards the locked position.

This kind of latch retention system is manufactured by dimensioning the fork and claw by making a compromise to balance between mechanical resistance and release forces. The more mass is added to the fork, the more the release force required to release the striker will increase, but the claw will be light and thus weaker to incoming forces. Conversely, if more mass is added to the claw, it will be maximized and the fork will be light, with a low release force.

In some applications, we the fork has to be made lighter, but the size (and hence mass) of the claw cannot be increased to geometrical constraints. In those cases, an alternative solution must be found to resist exceptional load cases when the geometry conditions are restrictive.

An object of the present invention is therefore to provide a door latch device that can prevent the door from being unlatched even under exceptional collision loads, even under difficult geometrical constraints.

To that end, the invention provides a door latch device for an automotive vehicle door comprising:
a base member having an insertion slot through which a striker can be inserted,
a holding fork, disposed on the base member, rotatable between a holding position in which it holds and immobilizes the striker and a releasing position in which its hold on the striker is released,
a locking claw disposed on the base member and rotatable between a locking position in which it locks the fork into the holding position and an unlocking position in which it unlocks the fork, the locking claw being biased from the unlocked position towards the locked position,

characterized in that the holding fork comprises a first locking protrusion facing a locking recess provided in the locking claw, such that engagement of the first locking protrusion in the locking recess locks the locking claw and the holding fork together, and a second locking protrusion configured to come into contact with an opposing side of the locking claw when the locking claw is in its locking position but the first locking protrusion is not in contact with a bottom surface of the locking recess.

As a result, the claw to which the collision load is applied via the striker and the fork comes into contact with the receiving portion when the claw is displaced in a direction outward from the fork. Therefore, displacement of the claw can be suppressed, and locking of the fork by the claw can be maintained. Therefore, it is possible to prevent the latch mechanism from being switched to the unlatched state, and thus it is possible to prevent unintended opening of the door.

In addition, thanks to the second locking protrusion provided on the fork, a mechanical resistance backup is provided even in the case of an exceptional mechanical load. Indeed, owing to the fact that the second locking protrusion only comes into contact with an opposing side of the claw when the first locking protrusion loses contact with a surface of the locking recess the second locking protrusion provides a backup in case of deformation or failure of the main teeth. Finally the addition of this second locking protrusion can be made even in tight geometrical constraints, and does not add much weight to the fork.

In a preferred example, when the claw is in its locking position, the second locking protrusion is located a distance from the fork on a side perpendicular to the direction in which the insertion slot extends.

Owing to the fact that the second locking protrusion is never in contact with the claw in normal use, when mechanical stresses deforms the fork, the second locking protrusion only gets in contact with the claw in case the first one fails.

In a preferred example, the second locking protrusion is located towards the outer side of the vehicle in the vehicle width direction with respect to the first locking protrusion.

In a preferred example, the claw comprises a protruding portion that fits into a recessed portion of the fork.

In a preferred example, the protruding portion of the claw is formed in a portion of the locking recess that is adjacent to the outer side of the locking recess in the vehicle width direction.

In a preferred example, the recessed portion of the fork is adjacent to the inner side of the first locking protrusion in the vehicle width direction.

In a preferred example, the second locking protrusion comes into contact with the outer side of the protruding portion of the claw in the vehicle width direction.

In a preferred example, the first locking protrusion and/or the second locking protrusion has a generally triangular shape.

In a preferred example, a portion of the claw has an arc shape centered about the axis of rotation of the claw.

In a preferred example, the door latch device further comprises a cover plate disposed on one side of the base member on which the fork and the claw are disposed and supporting one end of a rotation shaft of each of the fork and the claw, and further comprises a set plate arranged on the other surface side of the base member opposite to the one surface side and supporting the other end side of the fork and the claw opposite to the one end of the rotation shaft.

### BRIEF DESCRIPTION OF THE FIGURES

The invention will be better understood in view of the following description, referring to the annexed Figures in which:

FIG. 1 is schematic view of a door latch device according to a first embodiment of the present invention attached to a vehicle.

FIG. 2 is a perspective view of the door latch device of FIG. 1 with a cover plate removed.

FIG. 3 is an exploded perspective view of a base member and a latch mechanism of FIG. 2 viewed from a rear side in a vehicle length direction.

FIG. 4 is an exploded perspective view of a base member and a latch mechanism of FIG. 2 viewed from a front side in a vehicle length direction.

FIG. 5 is an exploded perspective view of the latch mechanism of FIG. 1

FIG. 6 is a front view of the latching mechanism of FIG. 1 in a latched state assembled to a base member.

FIG. 7 is a rear view of FIG. 6.

FIG. 8 is an enlarged view of the latching mechanism of FIG. 1 in the unlatched state.

FIG. 9 is an enlarged view of the detail IX shown on FIG. 6 of the latching arrangement in a latched condition.

FIG. 10 is an enlarged view of the detail X of FIG. 7

FIG. 11 is an enlarged view of the latching mechanism of FIG. 1 in the unlocked state.

FIG. 12 is cross-sectional view taken along a XII-XII line shown of FIG. 9

FIG. 13 is an enlarged view of detail XIII of FIG. 9

FIG. 14 is an enlarged view similar to FIG. 9 of the door latch device according to a second embodiment of the invention.

FIG. 15 is a perspective view of a door latch device according to a third embodiment of the invention.

FIG. 16 is an enlarged view similar to FIG. 9 of the door latch device according to the third embodiment of the invention.

FIG. 17 is a cross-sectional view taken along a XVII-XVII line of FIG. 16

FIG. 18 is an enlarged view similar to FIG. 9 of a door latch device according to a fourth embodiment.

FIG. 19 is a cross-sectional view taken along XIX-XIX line of FIG. 18

FIG. 20 is an enlarged view similar to FIG. 9 of a door latch device according to a fifth embodiment of the invention.

FIG. 21 is a cross-sectional view taken along a XXI-XXI line of FIG. 20.

### DETAILED DESCRIPTION

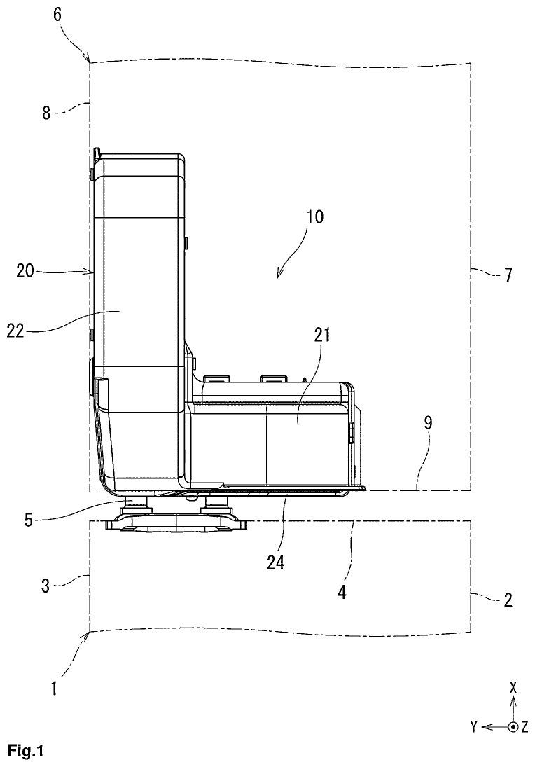

Referring to FIG. 1, a door latch device 10 according to a first embodiment of the present invention is disposed in a door 6 that is attached to a vehicle body 1 such that it may be closed or opened.

In the accompanying drawings, the X direction is the vehicle length direction, the direction indicated by the arrow is the front side, and the direction opposite to the arrow is the rear side. The Y direction is the vehicle width direction, the direction indicated by the arrow is the vehicle inner side, and the direction opposite to the arrow is the vehicle outer side. The Z direction is the vehicle height direction, and the direction indicated by the arrow is the upper side, and the direction opposite to the arrow is the lower side. Hereinafter, a state in which the door 6 is closed will be described as a standard state.

Vehicle body 1 includes an outer panel 2, an inner panel 3, and an end panel 4. The outer panel 2 and the inner panel 3 face each other and extend along the XZ plane. The end panel 4 is connected to a front end portion of each of the outer panel 2 and the inner panel 3 in the vehicle length direction, and extends along YZ plane. A U-shaped striker 5 is attached to the end panel 4 when viewed from the vehicle height direction so as to protrude in the vehicle length direction.

Door 6 includes an outer panel 7, an inner panel 8, and an end panel 9. The outer panel 7 and the inner panel 8 face each other and extend along XZ plane. The end panel 9 is continuous with the rear end portions of the outer panel 7 and the inner panel 8 in the vehicle length direction, extends along YZ plane, and faces the end panel 4 of the vehicle body 1.

Door 6 is a general-purpose door that can be rotated by a hinge shaft extending in the vehicle height direction. However, the door 6 may be a gullwing door that is rotatable by a hinge shaft extending in the vehicle longitudinal direction, a slide door that moves in the vehicle longitudinal direction along the vehicle body 1, or the like. In addition, in the present embodiment, the door 6 is a side door, but may be a hatch backdoor.

The door latch device 10 is disposed in the door 6 such that a portion thereof is extends from the end panel 9.

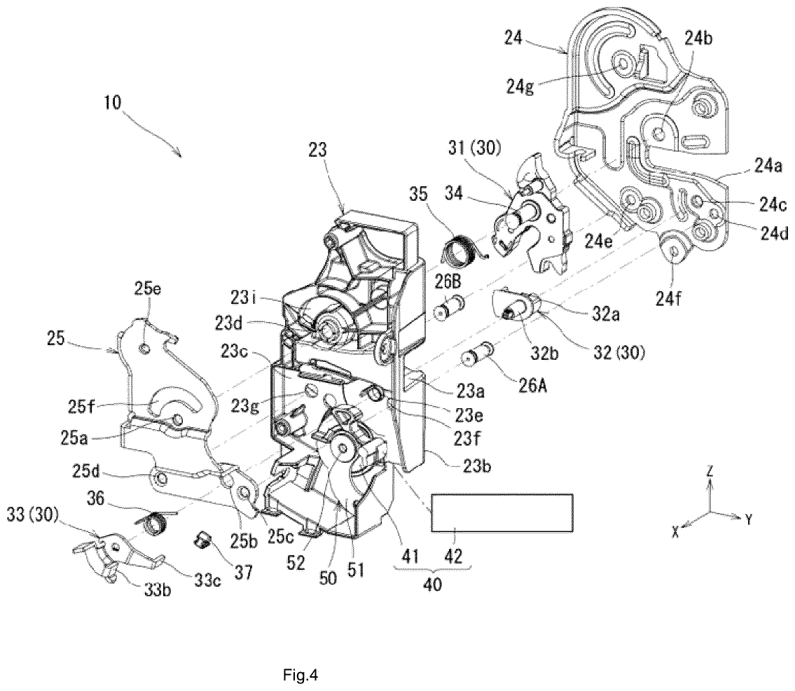

By holding the striker 5, the door 6 is held in a closed state with respect to the vehicle body 1. The door latch device 10 of the present embodiment is of an electric type that releases the holding of the striker 5 by the driving force of an actuator 42 (see FIG. 4). Therefore, an exposed door handle that is manually opened is not provided inside and outside the door 6. When the user in the vehicle opens the door 6, for example, a switch (not shown) provided in the door 6 is operated. When a user outside the vehicle opens the door 6, for example, an electronic key (not shown) is operated.

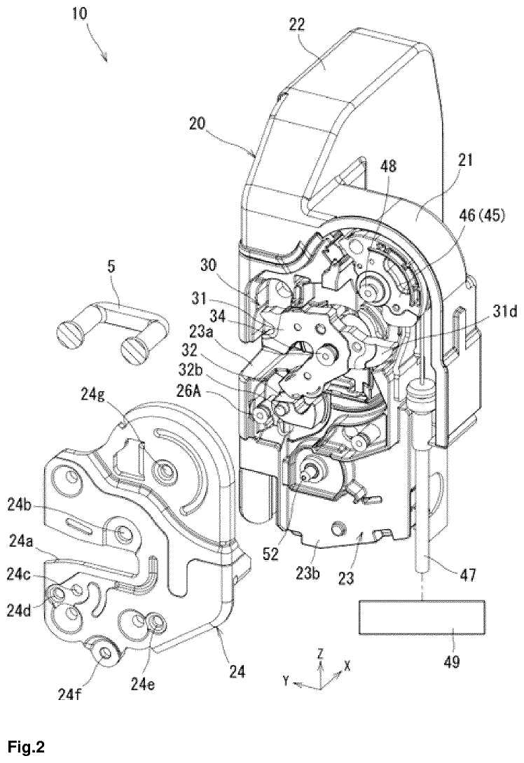

Referring to FIGS. 1 and 2, the door latch device 10 includes an L-shaped housing 20 when viewed from the vehicle height direction. Referring to FIGS. 2-4, the door latching device 10 includes, within the housing 20, a base member 23, a latching mechanism 30, a motorized release mechanism 40 and a motorized closure mechanism 45. Furthermore, the door latch device 10 includes a manual emergency release mechanism 50 that is not normally used and is used in case of an emergency, when the electric release mechanism 40 is inoperable.

Referring to FIGS. 1 and 2, housing 20 includes a first housing portion 21 arranged to extend in the vehicle width direction along the inner side of the end panel 9, and a second housing portion 22 arranged to extend in the vehicle length direction along the inner side of the inner panel 8. The second housing portion 22 extends from the inside end of the vehicle in the width direction towards the first housing portion 21, and spatially communicates with the first housing portion 21.

Base member 23 is disposed in the first housing portion 21 and includes an insertion slot 23a through which the striker 5 can be inserted. The insertion slot 23a forms a recess from an outer surface 23b oriented towards the rear side in the vehicle length direction towards an inner surface 23c side oriented towards the front side in the vehicle length direction. The insertion slot 23a extends along the vehicle width direction, forming an opening between an inner end in the vehicle width direction and a rear end in the vehicle width direction.

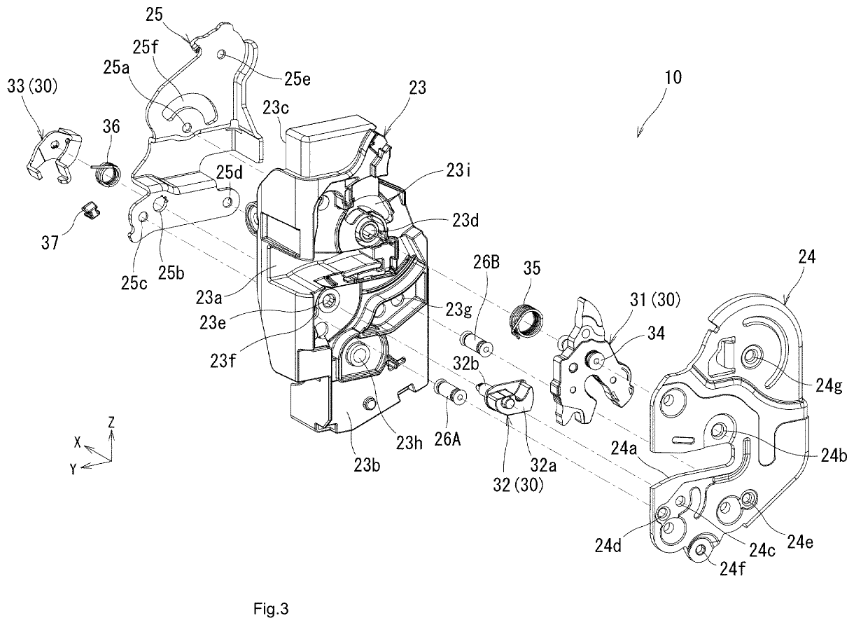

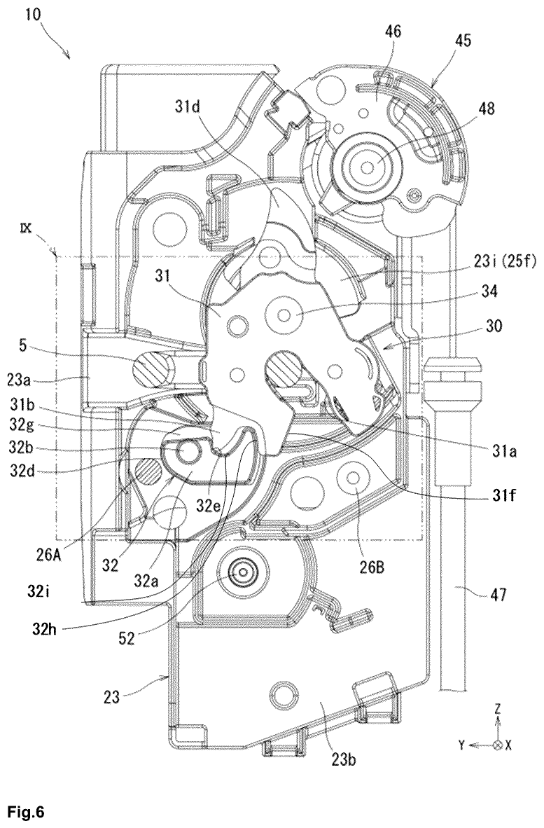

Referring to FIGS. 3 to 5, the latch mechanism 30 includes a holding fork 31, a locking claw 32, and an opening lever 33. The fork 31 and the claw 32 are rotatably disposed on the outer surface 23b of the base member 23. The opening lever 33 is disposed on the inner surface 23c of the base member 23 and rotates together with the claw 32. Referring to FIG. 6, a receiving shaft (receiving portion) 26A that suppresses unintentional displacement of the claw 32 is disposed on the inner side of the claw 32 in the vehicle width direction. The receiving shaft 26A will be described in detail later.

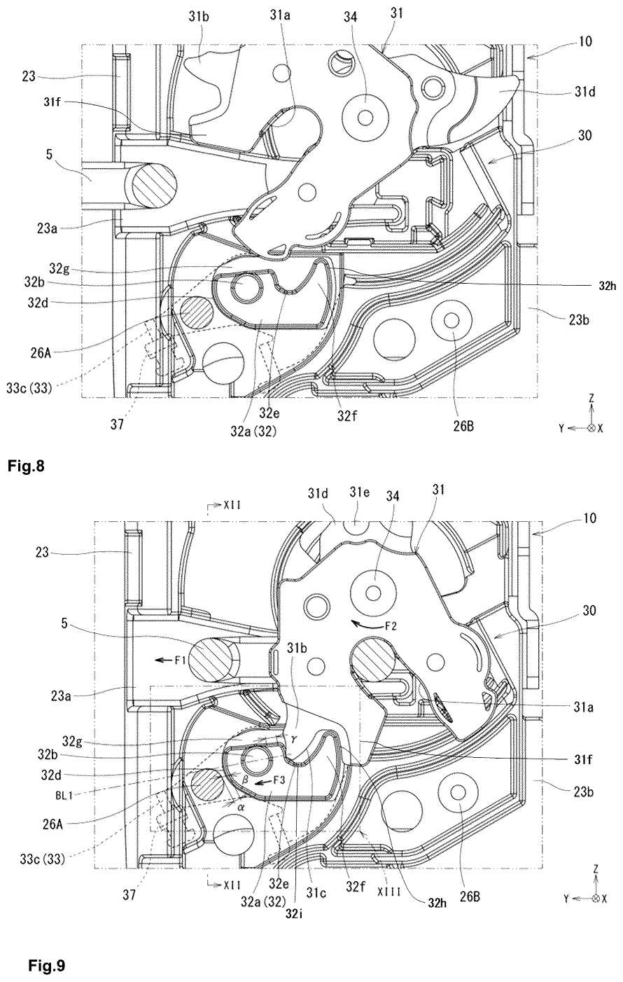

When the door 6 shown in FIG. 1 is closed in the unlatched state shown in FIG. 8, the entry of the striker 5 causes the fork 31 to rotate counterclockwise to a holding position shown in FIG. 9 in which it holds the striker 5, and the claw 32 rotates towards a locking position in which it locks the fork 31 in the holding position, thereby maintaining the door 6 in the closed state.

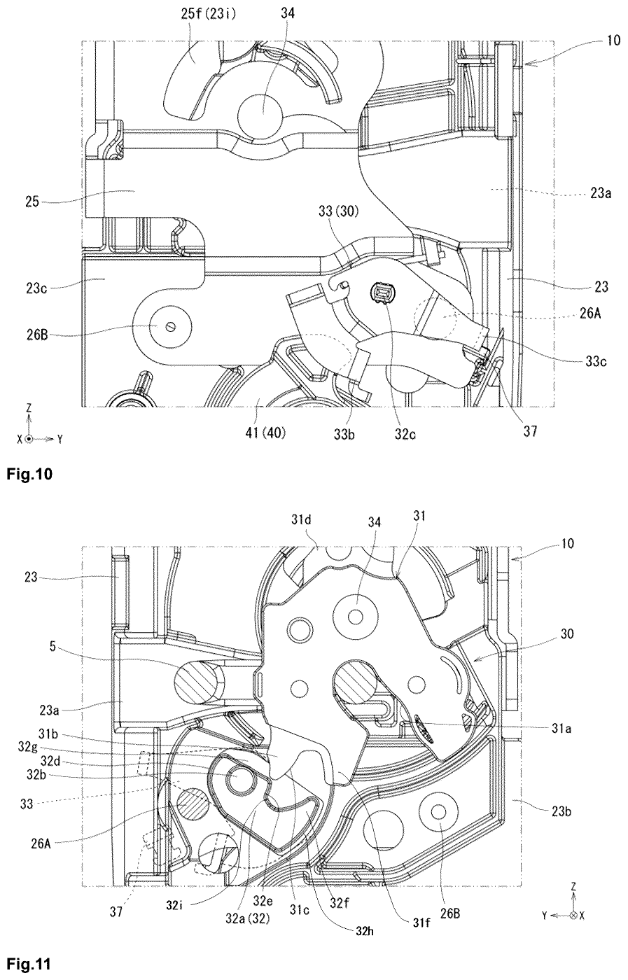

When the opening lever 33 in the initial position shown in FIG. 10 is rotated counterclockwise by the electric release mechanism 40 or the manual release mechanism 50, the claw 32 in the locking position shown in FIG. 9 is rotated clockwise to an unlocking position shown in FIG. 11. As a result, the fork 31 in the holding position shown in FIG. 11 rotates clockwise to the releasing position shown in FIG. 8, and the latch mechanism 30 is switched to the unlatched state. As a result, the striker 5 can be detached from the fork 31, and the door 6 can be opened with respect to the vehicle body 1.

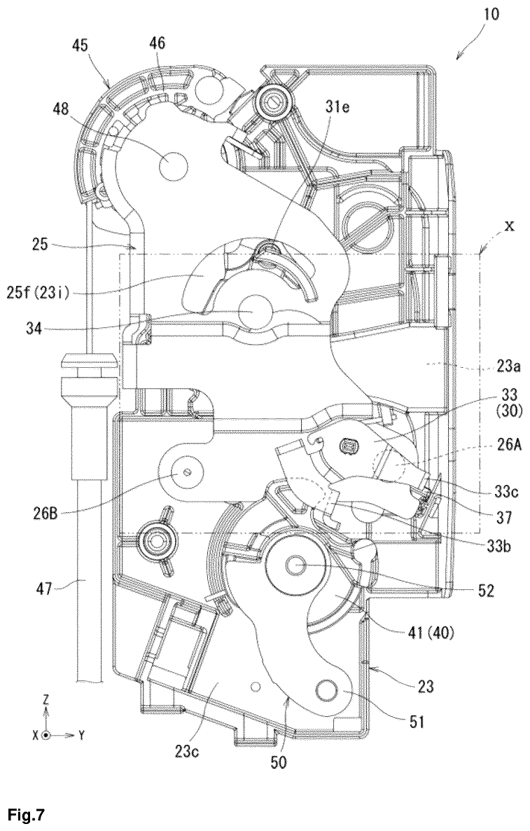

Referring to FIGS. 4 and 7, the electric release mechanism 40 includes an actuator 42 and an actuating member 41. The actuator 42 is disposed in the second housing portion 22 shown in FIG. 1. The actuating member 41 is rotatably disposed on the inner surface 23c of the base member 23.

Actuator 42 is actuated by a controller (not shown) to rotate actuating member 41 clockwise as shown in FIG. 7. Thus, the actuating member 41 rotates the opening lever 33 counterclockwise, thereby causing the claw 32 in the locking position shown in FIG. 9 to pivot to the unlocking position shown in FIG. 11 and the latch mechanism 30 to switch to unlatched. When the actuator 42 is stopped, the actuating member 41 returns to the initial position shown in FIG. 7 by the biasing force of a torsion spring (biasing member) (not shown).

Referring to FIGS. 2, 6, and 7, the closure mechanism 45 includes an actuator 49 and a closure lever 46. Actuator 49 is arranged in door 6 (see FIG. 1) externally to the housing 20. Closure lever 46 is rotatably arranged between the cover plate 24 and the set plate 25, which will be described in detail later, and is mechanically connected to the actuator 49 via a cable 47 arranged on the side surface of the base member 23.

When the open door 6 is closed and the fork 31, in the release position shown in FIG. 8, is rotated clockwise by a predetermined angle (for example, 39 degrees) toward the holding position shown in FIG. 9, the actuator 49 is driven by the control unit. As a result, the closure lever 46 is rotated clockwise as shown in FIG. 2 via the cable 47, and the fork 31 is rotated to the holding position shown in FIGS. 6 and 9 through contact with the receiving portion 31d, which will be described later. As a result, the claw 32 is locked to the fork 31. The latch mechanism 30 is thus switched to the latched state.

Referring to FIGS. 4 and 7, the manual release mechanism 50 includes an operating lever 51. The operating lever 51 is disposed on the inner surface 23c of the base member 23 and is rotatably supported by the same rotating shaft 52 as the actuating member 41. An emergency lever is connected to the operating lever 51 via a cable (not shown). The emergency lever is arranged in the vehicle and is normally covered by a cover.

When the emergency lever is operated in case of an emergency, the operating lever 51 is rotated clockwise as shown in FIG. 7. As a result, the opening lever 33 rotates via the actuating member 41. The claw 32 pivots from the locked position shown in FIG. 9 to the unlocked position shown in FIG. 11, and the latch mechanism 30 switches to unlatched.

The structures of the base member 23, the latching mechanism 30, and the receiving shaft 26A will now be described in more detail.

Referring to FIGS. 2 to 4, the base member 23 is made of plastic, and a large part of the outer surface 23b is covered by a metallic cover plate 24, and a part of the inner surface 23c is covered by a metallic set plate 25.

The base member 23 is provided with a through-hole 23d that allows the fork shaft (rotating shaft) 34 of the fork 31 to pass therethrough on the upper side of the insertion slot 23a. On a lower side of the insertion slot 23a, in other words on a side opposed to the fork 31 with respect to the insertion slot 23a, a through-hole 23e that allows the claw shaft (rotation shaft) 32b of the claw 32 to pass therethrough is provided. Through-hole 23e for claw 32 is spaced inwardly in the vehicle width wise with respect to the through-hole 23d for fork 31.

Base member 23 also comprises, located under through-hole 23e, through-holes 23f,23g for receiving shafts 26A,26B in order to fix set plate 25 to base member 23. Base member 23 also comprises a through-hole 23h intended for receiving rotating shaft 52 of the operating lever 51. Furthermore, an arc-shaped regulating groove 23i for regulating the rotational angle-range of fork 31 is provided above through-hole 23d.

Cover plate 24 includes an insertion slot 24a corresponding to the insertion slot 23a. Cover plate 24 also includes support holes 24b-2 corresponding through-holes 23d-23h of base member 23. Further, the cover plate 24 is provided with a support hole 24g corresponding to the rotating shaft 48 of the closure lever 46.

The set plate 25 is bent so as to conform to the inner surface 23c of the base member 23. The set plate 25 is provided with a support hole 25a-25e corresponding to the support hole 24b-24e,24g of the cover plate 24. Further, the set plate 25 is provided with a regulating groove 25f corresponding to the regulating groove 23i of the base member 23.

The cover plate 24 is fixed to the outer surface 23b of the base member 23 by introducing four shaft into set plate 23. Set plate 25 is fixed to the inner surface 23c of the base member 23. The first of the four shaft members is a metal fork shaft 34 included in the fork 31. The second of the four shaft members is a metal rotating shaft 48 included in the closure lever 46. The remaining two of the four shaft members are metallic receiving shafts 26A,26B which are spaced apart in the vehicle-width direction.

Referring to FIGS. 2 and 6, the fork 31 is disposed on the upper side of the insertion slot 23a of the base member 23. The fork shaft 34 of the fork 31 passes through the fork 31, the through-hole 23d of the base member 23, the support hole 24b of the cover plate 24, and the support hole 25a of the set plate 25, and is fixed to the cover plate 24 and the set plate 25, respectively. In other words one end of the fork shaft 34 is supported by the cover plate 24, and the other end of the fork shaft 34 is supported by the set plate 25. Thus, the fork 31 is rotatable about the fork shaft 34.

Referring to FIGS. 3 to 5, the fork 31 is biased from the holding position towards the releasing position by a torsion spring (biasing member) 35. The torsion spring 35 is arranged so as to surround the fork shaft 34. One end of the torsion spring 35 is fixed to the base member 23 and the other end is fixed to the fork 31.

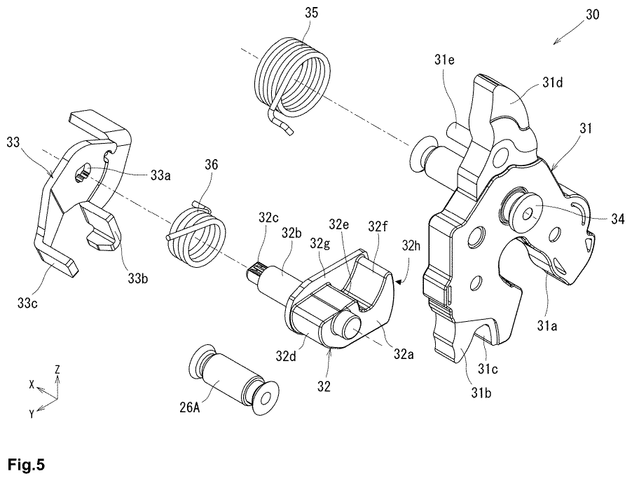

Referring to FIGS. 5 and 9, the fork 31 includes a holding groove 31a, a locking protrusion 31b, and a receiving portion 31d.

When in the open position shown in FIG. 8, the retaining groove 31a, extends upwardly sloping towards the outside in direction of the width of the vehicle, allowing the striker 5 to be released. When in the latched position shown in FIG. 9, the holding groove 31a intersects with the insertion slot 23a and slopes upwards towards the fork shaft 34 as it moves inwards in the direction of the width of the vehicle, thereby holding the striker 5 in a non-releasable manner.

The locking protrusion 31b on the inside of the fork 31 in the width direction of the vehicle and on the lower side of the fork 31 when in the holding position shown in FIG. 9. The locking protrusion 31b has a generally triangular shape.

The protrusion of the locking protrusion 31b forms an upward recess 31c in the portion of the locking portion 31b that is in contact with the outer side of the fork 31 in the direction of the vehicle width.

When the fork 31 is in the holding position shown in FIG. 9, the receiving portion 31d is placed at its upper end and protrudes in a generally triangular shape. The receiving portion 31d is configured to rotate the entire fork 31 to the holding position in response to an operation of the closure lever 46. The receiving portion 31d is provided with a regulating protrusion 31e that penetrates the regulating groove 23i of the base member 23 and the regulating groove 25f of the setting plate 25.

The fork 31 also comprises a second locking protrusion 31f configured to come into contact with an opposing side 32h of the locking claw 32 when the locking claw 32 is in its locking position but the first locking protrusion 31b is not in contact with a bottom surface 32i of the locking recess 32e, as will be described below.

The second locking protrusion 31f is located towards the outer side of the vehicle in the vehicle width direction with respect to the first locking protrusion 31b. The second locking protrusion 31f had an overall triangular shape.

However, it should be noted that when the claw 32 is in its locking position, the second locking protrusion 31f is located a distance from the fork 31 on a side perpendicular to the direction in which the insertion slot 23a extends. This prevents the second locking protrusion 31f from wear as it does not touch the claw 32 during a normal use. Indeed, the second locking protrusion 31f is only meant as a backup in case the first locking protrusion 31b is unable to secure a hold of the fork 31 by the claw 32.

Referring to FIGS. 3 to 5, claw 32 is composed of a claw body 32a and a claw shaft 32b formed in one piece to simplify the structure and improve ease of assembly. It is disposed below the insertion slot 23a of the base member 23. The claw shaft 32b is longitudinally oriented from the claw body 32a.

Claw shaft 32b protrudes to the front side and the rear side and can rotates together with the claw main body 32a. The rear end of the claw shaft 32b in the longitudinal direction is rotatably supported by the support hole 24c of the cover plate 24. The front side of the claw shaft 32b in the vehicle length direction passes through the through-hole 23e of the base member 23 and is rotatably supported by the support hole 25b of the setting plate 25. At the longitudinal front end of the claw shaft 32b, a mounting portion 32c having a non-circular cross section for mounting the opening lever 33 is provided.

The claw 32 is biased from the unlocked position towards the locked position by a torsion spring (biasing member) 36. Torsion spring 36 surrounds claw shaft 32b. One end of torsion spring 36 is fixed to the base member 23, and the other end is fixed to the opening lever 33. In other words, torsion spring 36 is attached to claw 32 via the opening lever 33.

Referring to FIG. 5 and FIG. 9, claw body 32a is a block body extending in the width direction of the vehicle. The inner end (in the vehicle width direction) of the claw main body 32a facing the receiving shaft 26A (hereinafter, referred to as an “facing portion 32d”) has an arc shape centered on the claw shaft 32b. The claw body 32a includes a locking recess 32e and a flange 32g.

The locking recess 32e is provided in a part of the claw 32 facing the locking protrusion 31b, and is recessed from the upper side towards the lower side to engage the locking protrusion 31b of fork 31. A protruding portion 32f that fits into the recessed portion 31c is formed in a portion of the locking recess 32e that is adjacent to the outer side of the locking recess 32e in the vehicle width direction.

The second locking protrusion 31f comes into contact with the outer side of the protruding portion 32f of the claw in the vehicle width direction.

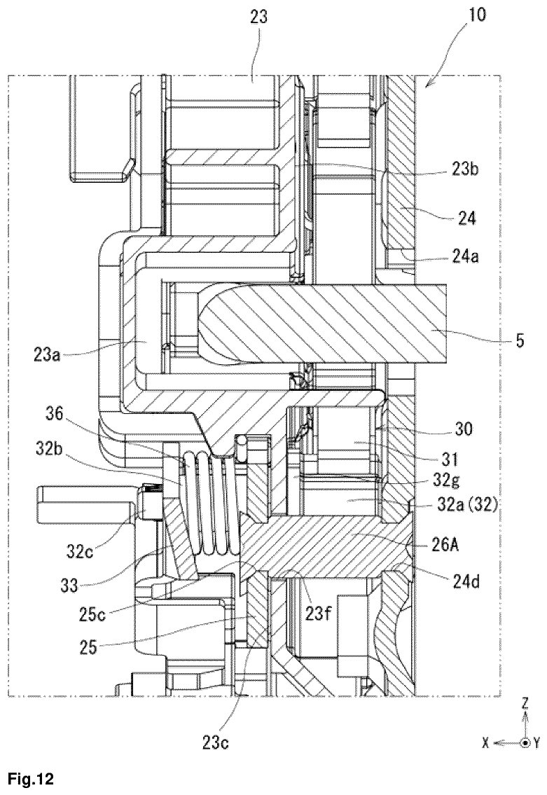

The flange 32g is provided in the front end (in the vehicle longitudinal direction) of the claw main body 32a facing the base member 23. The flange 32g protrudes from the outer periphery of the claw main body 32a parallel to the YZ plane and closes the front end of the locking recess 32e in the vehicle longitudinal direction. Referring to FIG. 12, the thickness of the flange portion 32g in the vehicle length direction is chosen such that it can be interposed between the fork 31 in the locking position and the base member 23.

Referring to FIGS. 4, 5, and 10, the opening lever 33 is disposed on a side opposite to the claw body 32a with respect to the base member 23, more specifically, on a front side of the setting plate 25 in the vehicle length direction. The opening lever 33 includes a non-circular attachment hole 33a attached to the attachment portion 32c of the claw shaft 32b, and rotates together with the claw 32. The opening lever 33 is provided with a receiving portion 33b that is actuated by the actuating member 41, and an abutting piece 33c that abuts against the stopper 37. The opening lever 33 is biased clockwise by a torsion spring 36 to the initial position shown in FIG. 10.

The stopper (restricting portion) 37 is made of elastically deformable rubber, is disposed on the inner surface 23c of the base member 23, and is sandwiched between the base member 23 and the setting plate 25. Abutment of the abutment of the abutment piece 33c of the opening lever 33 against stopper 37 prevents further counterclockwise rotation of the claw 32 beyond the locking position shown in FIG. 9.

In the case of an accident of the vehicle, in particular a side collision, the door latch device 10 exhibits the behaviour described below.

As shown by the arrows on FIG. 9, when the door 6 shown in FIG. 1 is deformed in the case of an impact, a load F1 may act upon the striker 5 and displace in the direction of exiting the insertion groove 23a.

As such, the striker 5 exerts a force F2 on the fork 31 which rotates clockwise from the holding position towards the release position. Thus, the claw 32 engaged with the fork 31, is subjected to a force F3 which displaces the claw 32.

If the displacement is excessive, such as when a very high load is exerted upon the claw 32, the claw 32 may be disengaged from the fork 31. In that case, there is a possibility that the latch mechanism 30 unlatches and the door 6 shown in FIG. 1 becomes open.

To prevent this, the second locking protrusion 31f is configured to come into contact with an opposing side 32h in case the first locking protrusion 31b is not in contact anymore with a bottom surface 32i of the locking recess 32e. This can for example happen in case of a deformation of the first locking protrusion 31b. In that case, the second locking protrusion 31f will come into contact with the opposing side 32h of the claw 32 and be subjected to the load received by the fork 31. Thus, the claw 32 is still engaged with the fork 31, and the latch mechanism 30 will not unlatch and cause the door 6 to open.

In addition, the second locking protrusion 31f can include a self closure profile geometry, in order to maintain a high strength performance and thus a secure hold of the fork 31 by the claw 32.

To further prevent a latch release due to the deformation of the door 6 by such a collision load input, in the present embodiment, the receiving shaft 26A is arranged to restrain the displacement of the claw 32.

Referring to FIGS. 2 and 9, the receiving shaft 26A is provided on the inner side in the vehicle width direction with respect to the claw 32 when it is in its locking position. In other words, it is located opposite the direction in which the insertion slot 23a extends from the fork 31, and prevents the displacement of the claw 32 under an impact load input. In other words, the receiving shaft 26A is provided on the front side of the direction in which the claw 32 is displaced by the impact load.

The receiving shaft 26A is a rigid body that is harder than the plastic base member 23 and extends parallel to the claw shaft 32b. Referring to FIG. 12, both ends of the receiving shaft 26A are supported by a support hole 24d of the cover plate 24 and a support hole 25c of the set plate 25, respectively.

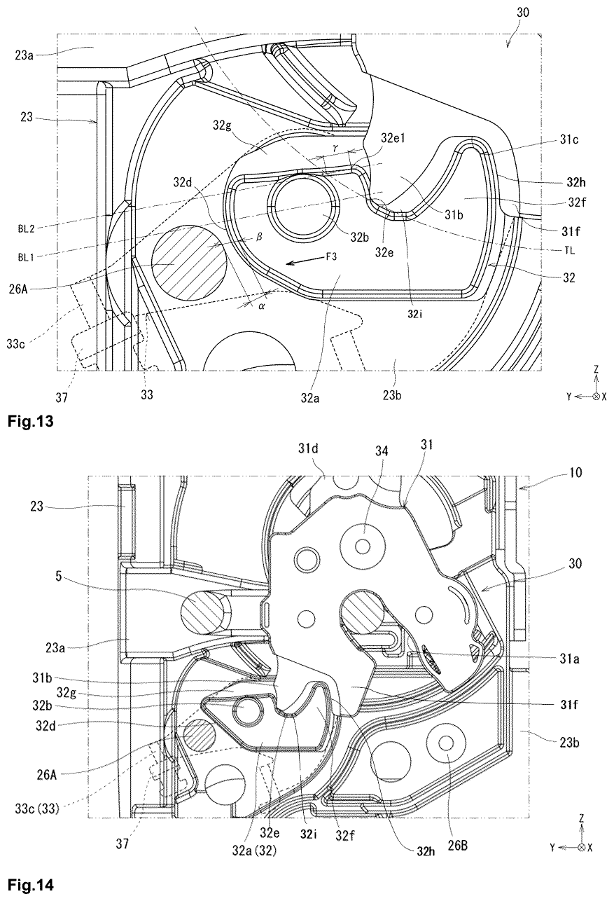

Referring to FIG. 13, the receiving shaft 26A is positioned at a distance α and a distance β from the facing portion 32d of the claw main body 32a in the direction in which the insertion slot 23a extends. In other words, a gap between the receiving shaft 26A and the claw main body 32a is secured. The distance α is the shortest distance between the receiving shaft 26A and the facing portion 32d of the claw main body 32a. The distance β is the shortest distance between the receiving shaft 26A and the claw body 32a in the direction of the force F3 acting on the claw 32. In the present embodiment, a straight line (hereinafter, referred to as a “reference line BL1”) passing through the contact position between the locking protrusion 31b and the locking recess 32e and the center of the fork shaft 34 when the claw 32 is locked to the fork 31 is the direction of the force F3 acting on the claw 32. However, the direction of the force F3 acting on the claw 32 may be derived by simulating or experimenting with the three-dimensional data of the door latch device 10.

The interval α is less than or equal to the interval β (α≤β). The distance α and the distance β are smaller than the distance γ between the locking protrusion 31b of the fork 31 and the locking recess 32e of the claw 32 (α≤β<γ). The engagement margin γ represents a moving range of the claw 32 in which the claw 32 can be locked to the fork 31 at the latching position. It is also a distance between an intersection of a reference line BL2 which passes through the open upper end 32e1 of the locking recess 32e and is parallel to the reference line BL1, and a rotational trajectory of the leading end of the locking protrusion 31b indicated by the imaginary line TL, and an upper end 32e1 of the locking recess 32e.

If the intervals α and β are excessively increased, the locking of the locking protrusion 31b and the locking recess 32e may be released before the claw 32 abuts the receiving shaft 26A when it is displaced by an impact load exerted upon it. If the distance α and the distance β are excessively small, the claw body 32a may interfere with the receiving shaft 26A due to an a potential manufacturing error or the like in a normal state in which the claw 32 rotates between the locking position shown in FIG. 9 and the unlocking position shown in FIG. 11, and may hinder the rotation of the claw 32.

In order to prevent these inconveniences, it is preferable to provide, between the receiving shaft 26A and the claw main body 32a, a distance α, β smaller than the engagement margin γ of the locking recess 32e with the locking protrusion 31b. For example, when the margin γ is 1.55 mm, the interval α and β are preferably greater than 0 mm and less than 1 mm (more specifically, 0.5 mm±0.5 mm).

Referring to FIG. 12, the receiving shaft 26A overlaps with the claw main body 32a when viewed from a direction in which the insertion slot 23a extends (vehicle-width direction). In the present embodiment, the diameter of the receiving shaft 26A is smaller than the width from the upper end to the lower end of the claw main body 32a in the locking position. The claw body 32a overlapping with the receiving shaft 26A means that at least a portion of the receiving shaft 26A is located within the width of the claw body 32a in the vehicle height direction. In this particular example, the entire receiving shaft 26A is located within the width of the claw body 32.

Referring to FIG. 9, the receiving shaft 26A is disposed on reference line BL1 and extends along the insertion slot 23a of the base member 23. The arrangement of the receiving shaft 26A on the standard line BL1 means that a part of its cross section in the receiving axis 26A is located on the reference line BL1. Moreover, in the present embodiment, the center of the cross section of receiving axis 26A in the receiving axis 26A is located lower than reference line BL1.

Due to this particular arrangement of the receiving shaft 26A, and as shown in FIG. 9, when a force F3 is applied to the claw 32 via the striker 5 and fork 31 during deformation of the door 6 due to a collision load input, the claw 32 which is displaced along direction of the force F3 abuts the receiving shaft 26A. Since the distance α and β between the claw 32 and the receiving shaft 26A are smaller than the engagement margin γ between the fork 31 and the claw 32, the claw 32 can abut on the receiving shaft 26A prior to the unlocking of the fork 31 by the claw 32. As a result, it is possible to prevent the latch mechanism 30 from being unlatched due to the deformation of the door 6 caused by the impact load input.

The door latch device 10 configured as described above has the following features.

A receiving shaft (receiving portion) 26A is provided at an interval α between the claw 32 at the locking position and the fork 31 and the insertion slot 23a. As a result, when the claw 32 to which the impact load is applied is displaced outward from the fork 31, it abuts with the receiving shaft 26A

Therefore, displacement of the claw 32 and deformation of the claw shaft 32b can be suppressed, and locking of the fork 31 by the claw 32 can be maintained. Therefore, the latch mechanism 30 can be prevented from being switched to the unlatched state, so that unintentional opening of the door 6 can be prevented. The receiving shaft 26A is provided separately from the stopper 37 that restricts the rotation of the claw 32, and is positioned at a distance α from the claw 32. Therefore, since the claw 32 and the receiving shaft 26A do not interfere with each other during normal operation and traveling of the claw 32, generation of abnormal noise can be prevented.

The distance α and β between the receiving shaft 26A and the claw 32 is smaller than the engagement margin γ between the claw 32 at the locking position and the fork 31 at the latching position. As a result, the claw 32 comes into contact with the receiving shaft 26A prior to the disengagement of the claw 32 from the fork 31. Therefore, locking of the claw 32 to the fork 31 can be reliably maintained, and unintended opening of the door 6 can be reliably prevented.

When viewed from the extension of the insertion slot 23a, the receiving shaft 26A is provided at a position overlapping with the claw 32. Thus, the displaced claw 32 can be received by the receiving shaft 26A. Therefore, locking of the claw 32 to the fork 31 can be reliably maintained, and unintended opening of the door 6 can be reliably prevented.

The facing portion 32d of the claw 32 facing the receiving shaft 26A has an arc shape centered on the claw shaft 32b. As a result, the displaced claw 32 can be reliably received by the receiving shaft 26A. In addition, since the claw 32 and the receiving shaft 26A do not interfere with each other during normal operation and traveling of the claw 32, generation of abnormal noise can be effectively prevented.

The claw 32 has a flange 32g interposed between the fork 31 in the latching position and the base member 23. As such, flange 32g can prevent the claw 32 from being displaced along the claw axis 32b. Therefore, the lock of the claw 32 to the fork 31 can be reliably maintained, and unintended opening of the door 6 can be reliably prevented.

The receiving shaft 26A is a rigid body harder than the base member 23, and both ends thereof are supported by the metallic cover plate 24 and the setting plate 25, respectively. This prevents displacement and deformation of the receiving shaft 26A and ensures that it reliably receives the displaced claw 3. This prevents the latch mechanism 30 to become unlatched.

Other embodiments and various variations of the invention are described below. In what follows, points not specifically mentioned are the same as in the first embodiment. In the drawings referred to below, elements identical to the first embodiment are marked with the same symbols.

We will now describe a second embodiment of the invention referring to FIG. 14. The door latch device 10 of the second embodiment differs from the first embodiment shown in FIG. 9 only in the shape of the claw body 32a.

Specifically, in the second embodiment, the facing portion 32d of the claw main body 32a is inclined towards the fork shaft 34 as it approaches the receiving shaft 26A. A portion of the inner edge (in the vehicle width direction) of the facing portion 32d is disposed above the upper end of the receiving shaft 26A, and closer to the inner side of the vehicle in width direction than the receiving shaft 26A.

The remaining part of the facing portion 32d is located below the upper end of the receiving shaft 26A and closer to the outside of the vehicle in the width direction than the outer end (in the vehicle width direction) of the receiving shaft 26A. In other words, the inner end of the facing portion 32d is located further from the fork 31 than the upper end of the receiving shaft 26A in the vehicle height direction, and further from the fork 34 than the outer end of the receiving shaft 26A in the direction in which the insertion slot 23aextends.

In this second embodiment, when the claw 32 is displaced via the striker 5 and the fork 31 under the impact load, the inclined facing portion 32d functions as a guiding portion. Specifically, when the facing portion 32d comes into contact with the receiving shaft 26A, the entire claw 32 moves towards the fork shaft 34, in other words in a direction in which the relationship between the claw 32 and the fork 31 becomes deeper. Therefore, the locking of the claw 32 to the fork 31 can be reliably maintained, and the unlatching the latch mechanism 30 can be prevented. Therefore, unintended opening of the door 6 (see FIG. 1) can be reliably prevented.

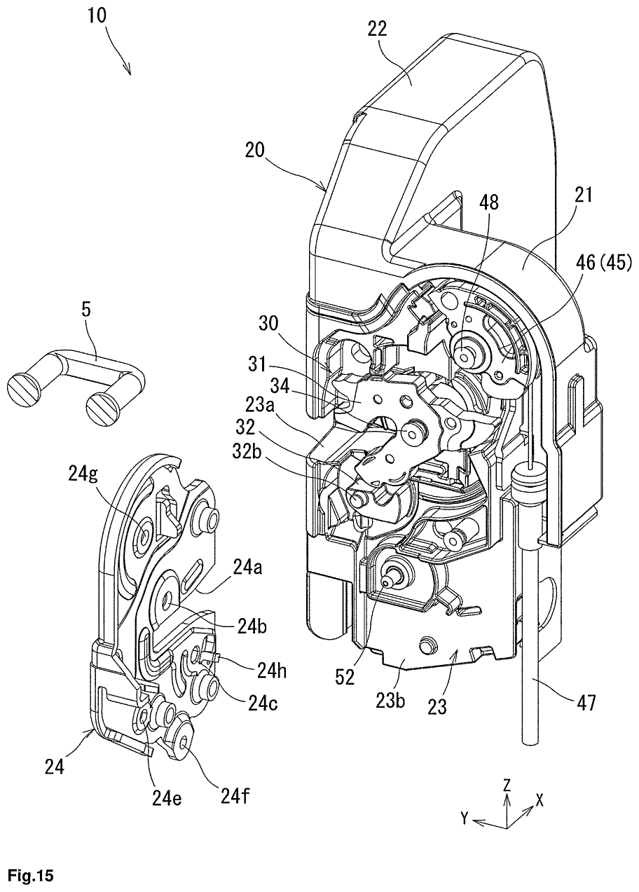

We will now describe a third embodiment of the invention referring to FIGS. 15 to 17. The door latch device 10 of the third embodiment differs from the first embodiment shown in FIG. 9 only in the structure of the receiving portion.

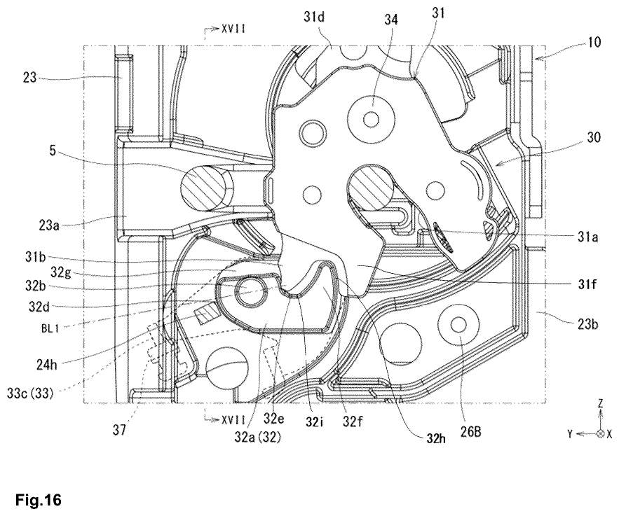

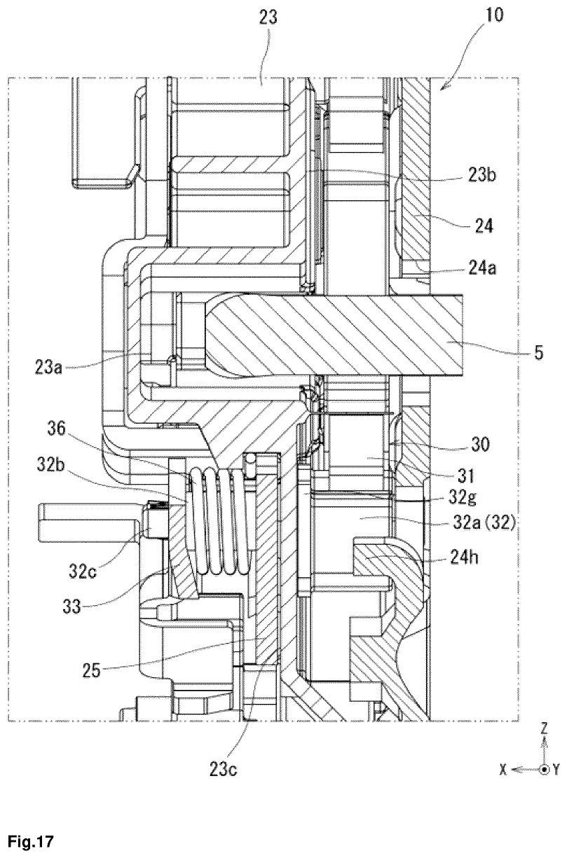

Specifically, the receiving portion of the third embodiment is made of a cutout 24h formed in a metallic cover-plate 24 which is a rigid body harder than the fence-block 23. An inverted U-shaped punching groove is provided in the cover plate 24, and a section located in the punching groove is bent toward the front side in the vehicle length direction, thereby forming a bent cutout 24h. By assembling the cover plate 24 to the base member 23, cutout 24h is bent forward in the vehicle width direction towards the claw 32 as shown in FIG. 16, extends along the reference line BL1, and is positioned within the width of the claw 32 in the vehicle height direction as shown in FIG. 17.

In this third embodiment, when the claw 32 is displaced via the striker 5 and the fork 31 under the impact load, the displaced claw 32 can be received by the cutout 24h as in the first embodiment. As a result, unlocking of the fork 31 by the claw 32 can be prevented, so that the unlatching of the latch mechanism 30 can be prevented, and unintended opening of the door 6 (see FIG. 1) can be prevented. Furthermore, since the receiving portion is made of a cutout 24h provided from the cover plate 24, the addition of a dedicated component is not required, which simplifies the manufacturing.

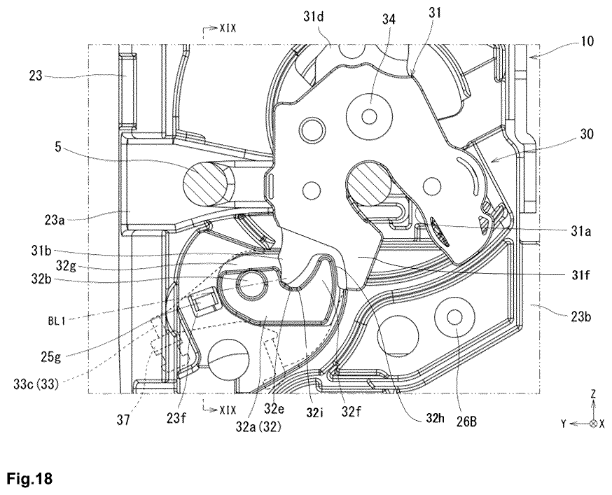

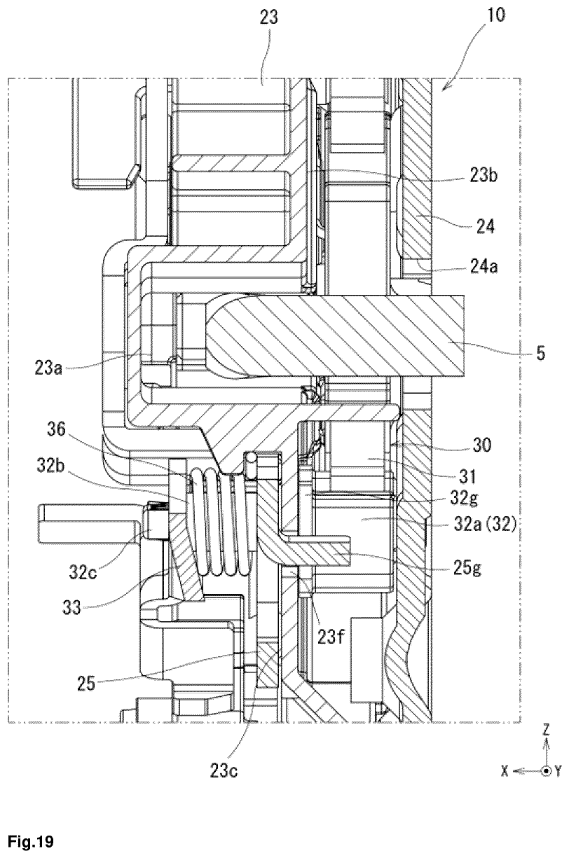

We will now describe a fourth embodiment of the invention referring to FIGS. 18 and 19. The door latch device 10 of the fourth embodiment differs from the first embodiment shown in FIG. 9 only in the structure of the receiving portion. Specifically, the receiving portion of the fourth embodiment is made of a cutout 25g formed in the metallic set plate 25, which is a rigid body harder than the base member 23. A U-shaped punching groove is provided in the setting plate 25, and a section located in the punching groove is bent toward the rear side in the vehicle length direction, thereby forming a cutout 25g.

By assembling the set plate 25 to the snub block 23, the cutout 25g is bent inward in the vehicle width direction of the claw 32 through the through-hole 23f, extends along the reference line BL1, and is located within the width of the claw 32 in the vehicle height direction.

In this fourth embodiment, when the claw 32 is displaced via the striker 5 and the fork 31 under the impact load, the displaced claw 32 can be received by the cutout 25g as in the first embodiment. As a result, unlocking of the fork 31 by the claw 32 can be prevented, so that the unlatching of the latch mechanism 30 can be prevented, and unintended opening of the door 6 (see FIG. 1) can be prevented. Furthermore, since the receiving portion is made of a cutout 24h provided from the cover plate 24, the addition of a dedicated component is not required, which simplifies the manufacturing.

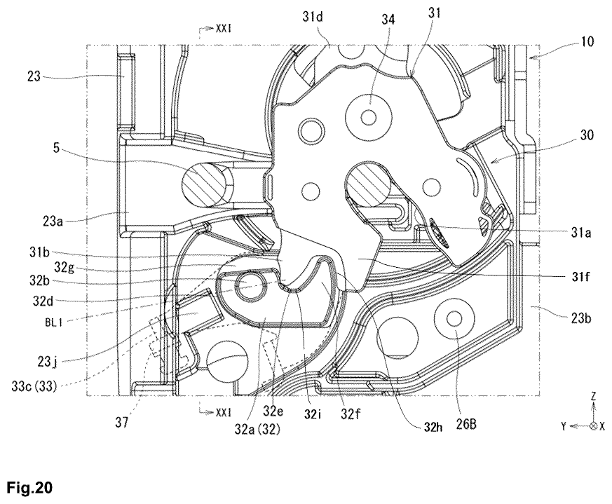

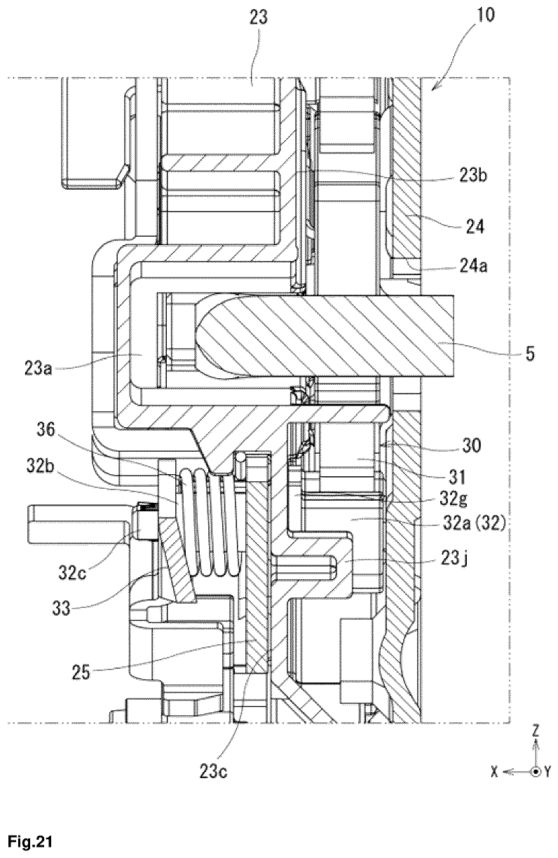

We will now describe a fifth embodiment of the invention referring to FIGS. 20 and 21. The door latch device 10 of the fifth embodiment differs from the first embodiment shown in FIG. 9 only in the structure of the receiving portion. Specifically, the receiving portion of the fifth embodiment is formed of a protruding portion 23j formed in the base member 23. The protruding portion 23j is integrally formed with the plastic base member 23 and protrudes from the outer surface 23b of the base member 23 towards the cover plate 24. The outer end of the protruding portion 23j is spaced apart from the claw 32 in the vehicle width direction, and the inner end of the protruding portion 23j in the vehicle width direction is connected to the side wall of the base member 23. In other words, the protrusion 23j extends along the insertion slot 23a and the reference line BL1.

In this fifth embodiment, when the claw 32 is displaced via the striker 5 and the fork 31 under the impact load, the displaced claw 32 can be received by the protruding portion 23j as in the first embodiment. At this time, the protruding portion 23j is integrally formed with the plastic member 23, but extends in the direct along which the claw 32 is displaced.

Since it is connected to the side wall of the base member 23, the protruding portion 23j has a high load resistance in the vehicle width direction. As a result, unlocking of the fork 31 by the claw 32 can be prevented, so that unlatching of the latch mechanism 30 to can be prevented, as well as an unintended opening of the door 6 (see FIG. 1). Furthermore, since the receiving portion is made of a protruding portion 23j provided from the base member 23, the addition of a dedicated component is not required, which simplifies the manufacturing.

The invention is not limited to the particular embodiments described, and various changes can be envisioned.

For example, the door latch device 10 of the second embodiment shown in FIG. 14 may include by the receiving portion of the third embodiment comprising the raised piece 24h shown in FIG. 17, the receiving portion of the fourth embodiment comprising the raised piece 25g shown in FIG. 19 or the fifth embodiment receiving portion comprising the protruding portion 23j shown in FIG. 21.

In addition, the receiving portion may be provided on any part or provided as a dedicated part as long as the displacement of the claw 32 due to collision load input is prevented.

The claw shaft 32b may be provided separately from the claw body 32a, and the claw body 32a may be rotatable about the claw shaft 32b.

If the rotation of the claw 32 beyond the locking position can be restricted through the opening lever 33 in the normal state, the receiving portion may be constituted by a part of the base member 23 or a part of the set plate 25 without providing a separate stopper 37. Further, the restricting portion may be configured to restrict the rotation of the claw 32 beyond the locking position by directly abutting against the claw 32.

As long as the claw 32 is prevented from being displaced by the impact load, the receiving portion may be provided at a position that does not overlap the claw 32 when viewed from the direction in which the insertion slot 23a extends.

The facing portion 32d of the claw 32 may having another shape than an arc shape or an inclined shape as long as the claw 32 can be prevented from being unlocked from the fork 31 by the impact load.

As long as the claw 32 can be prevented from being displaced along the claw axis 32b in the vehicle length direction, the flange portion 32g of the claw 32 may not be provided.

### LIST OF REFERENCES

1: Vehicle body
2: Vehicle outer panel
3: Vehicle inner panel
4: Vehicle end panel

### 5: Striker

6: Vehicle door
7: Door outer panel
8: Door inner panel
9: Door end panel
10: Door latch device

### 20: Housing

21: First housing portion
22: Second housing portion
23: Base member
23a: Insertion slot
23b: Outer surface of the base member
23c: Inner surface of the base member
23d˜23h: Through-holes
23i: Regulating groove
23j: Protruding portion
24: Cover plate
24a: Insertion slot
24b˜24g: Support hole

### 24h: Cutout

25: Set plate
25a˜25e: Support hole
25f: Regulating groove

### 25g: Cutout

26A, 26B: Receiving shaft
30: Latch mechanism

### 31: Fork

31a: Retaining groove
31b: First locking protrusion

### 31c: Recess

31d: Receiving portion
31e: Regulating protrusion
31f: Second locking protrusion

### 32: Claw

32a: Claw body
32b: Claw shaft (rotating shaft)
32c: Mounting portion
32d: Facing portion
32e: Locking recess
32f: Protruding portion of the claw

### 32g: Flange

32h: Opposing side of the locking claw
32i: Bottom of the locking recess

### 33: Open-lever

33a: Attachment hole
33b: Receiving portion
33c: Abutment piece
34: Fork shaft (rotating shaft)
35,36: Torsion spring (biasing member)
37: Stopper (Regulatory part)
40: Electric release mechanism
41: Actuating member

### 42: Actuator

45: Closure mechanism
46: Closure lever

### 47: Cable

48: Rotating shaft

### 49: Actuator

50: Manual release mechanism
51: Operating lever
52: Rotating shaft
α: Interval (shortest distance between the receiving shaft and claw body)
β: Interval (shortest distance between the receiving axis and the claw body in the direction in which the claw is displaced)
γ: Engagement margin (distance between the locking protrusion of the fork and the locking recess of the claw)

1. A door latch device for an automotive vehicle door comprising:
a base member having an insertion slot through which a striker can be inserted,
a holding fork, disposed on the base member, rotatable between a holding position in which it holds and immobilizes the striker and a releasing position in which its hold on the striker is released,
a locking claw disposed on the base member and rotatable between a locking position in which it locks the fork into the holding position and an unlocking position in which it unlocks the fork, the locking claw being biased from the unlocked position towards the locked position,
wherein the holding fork comprises a first locking protrusion facing a locking recess provided in the locking claw, such that engagement of the first locking protrusion in the locking recess locks the locking claw and the holding fork together, and a second locking protrusion configured to come into contact with an opposing side of the locking claw when the locking claw is in its locking position but the first locking protrusion is not in contact with a bottom surface of the locking recess.

2. The door latch device according to claim 1, further comprising a latch mechanism that may be switched from a latched state preventing the vehicle door from being opened, to an unlatched state allowing the vehicle door to be opened and wherein, when the second locking protrusion is in contact with the opposing side of the locking claw, said second locking protrusion is subjected to the load received by the fork such that the claw is still engaged with the fork and the latch mechanism will not switch to the unlatched state.

3. The door latch device according to claim 1, wherein, when the claw is in its locking position, the second locking protrusion is located a distance from the fork on a side perpendicular to the direction in which the insertion slot extends.

4. The door latch device according to of the preceding claims claim 1, wherein the second locking protrusion (31f) is located towards the outer side of the vehicle in the vehicle width direction with respect to the first locking protrusion (31b).

5. The door latch device according to any one claim 1, wherein the claw comprises a protruding portion that fits into a recessed portion of the fork.

6. The door latch device according to claim 5, wherein the protruding portion of the claw is formed in a portion of the locking recess that is adjacent to the outer side of the locking recess in the vehicle width direction.

7. The door latch device according to claim 5, wherein the recessed portion of the fork is adjacent to the inner side of the first locking protrusion in the vehicle width direction.

8. The door latch device according to claim 5, wherein the second locking protrusion comes into contact with the outer side of the protruding portion of the claw in the vehicle width direction.

9. The door latch device according to claim 1, wherein the first locking protrusion and/or the second locking protrusion has a generally triangular shape.

10. The door latch device according to claim 1, wherein a portion of the claw has an arc shape centered about the axis of rotation of the claw.

11. The door latch device according to claim 1, wherein it further comprises a cover plate disposed on one side of the base member on which the fork and the claw are disposed and supporting one end of a rotation shaft of each of the fork and the claw, and further comprises a set plate arranged on the other surface side of the base member opposite to the one surface side and supporting the other end side of the fork and the claw opposite to the one end of the rotation shaft.
